(19) United States
(12) Patent Application Publication
(10) Pub. No.: US 2023/0400756 A1
(43) Pub. Date: Dec. 14, 2023

(54) PROJECTION APPARATUS AND CALIBRATION METHOD

(71) Applicant: Coretronic Corporation, Hsin-Chu (TW)

(72) Inventors: Chia-Cheng Wu, Hsin-Chu (TW); Chia-Chi Chung, Hsin-Chu (TW)

(73) Assignee: Coretronic Corporation, Hsin-Chu (TW)

(21) Appl. No.: 18/457,373

(22) Filed: Aug. 29, 2023

Related U.S. Application Data
(63) Continuation-in-part of application No. 17/695,847, filed on Mar. 16, 2022, now abandoned.

(30) Foreign Application Priority Data
Mar. 29, 2021 (CN) 202110335731.1

(51) Int. Cl. G03B 21/14; G03B 21/53

(52) U.S. Cl. CPC G03B 21/142; G03B 21/53

(57) ABSTRACT

A projection apparatus is provided, including a lens module, a movement element, a sensing element, and a lens control element. When the lens module moves to the origin position, the lens control element controls an image beam to focus on a first position on a reference plane in one of the tele mode and the wide mode, the lens control element controls the image beam to focus on a second position on the reference plane in the other mode, and the lens control element determines whether there is an offset between the first position and the second position. When the offset exists, the lens control element adjusts a movement parameter value of the movement element based on the offset value between the first position and the second position, so that the image beam is focused on the same position on the reference plane in the tele mode and wide mode.

### CROSS-REFERENCE TO RELATED APPLICATION

This application is a continuation-in-part application of U.S. patent application Ser. No. 17/695,847, filed on Mar. 16, 2022. The prior application Ser. No. 17/695,847 claims the priority benefit of China application serial no. 202110335731.1, filed on Mar. 29, 2021. The entirety of each of the above-mentioned patent applications is hereby incorporated by reference herein and made a part of this specification.

### BACKGROUND

### Technical Field

The invention relates to a projection apparatus and a calibration method.

### Description of Related Art

In the existing projector, after the lens shift module of the lens apparatus finishes calibrating the lens, the zoom ring on the lens is rotated to adjust the lens position to enter the wide mode or the tele mode. However, due to structural reasons like the accumulated tolerances and the assembly tolerances of the components, the origin of the imaging screen may shift when entering the wide mode or the tele mode. Generally, different lens specifications have different allowable ranges for such offset. When the offset is within the allowable range, the image is not deemed affected. However, once the offset exceeds the allowable range, the imaging performance differs in the wide mode and the tele mode, and there may be dark corners so that the image quality will be affected. Moreover, it is difficult to control the drift of the image center formed by the structural tolerances of the components.

To reduce the offset as described, generally, it is necessary to limit the component tolerance and the assembly tolerance to improve the accuracy of the processed components of the lens shift module. However, this strategy also reduces the yield rate and increases the cost of components and the difficulty in assembly.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides a projection apparatus and a calibration method capable of providing good image quality in a tele mode and a wide mode.

Other objectives and advantages of the invention may be further understood from the technical features disclosed in the invention.

To achieve one or part or all of the above objectives or other objectives, an embodiment of the invention provides a projection apparatus. The projection apparatus includes a lens module, a movement element, a sensing element, and a lens control element. The lens module has a tele mode and a wide mode, and the lens module is adapted to focus an image beam on a reference plane in the tele mode and the wide mode. The movement element is adapted to adjust the position of the lens module. The sensing element is adapted to detect the position of the lens module. The lens control element is electrically connected to the lens module, the movement element, and the sensing element, wherein: when the movement element drives the lens module to move to the origin position, the lens module triggers the sensing element, the sensing element provides an origin-position information signal to the lens control element, the lens control element controls the movement element to stop the lens module from moving, and the lens control element sets the movement parameter value of the movement element to an origin parameter value, the lens control element controls the image beam to focus on a first position on the reference plane in one of the tele mode and the wide mode; the lens control element controls the image beam to focus on a second position on the reference plane in the other one of the tele mode and the wide mode; and the lens control element determines whether there is an offset between the first position and the second position; and when the lens control element determines there is an offset value between the first position and the second position, the lens control element correspondingly adjusts movement parameter values of the movement element in the tele mode and the wide mode correspondingly based on the offset value between the first position and the second position, so that the image beam is focused on the same position on the reference plane after the adjustments are made in the tele mode and the wide mode.

To achieve one or part or all of the above objectives or other objectives, an embodiment of the invention provides a calibration method. The calibration method is adapted to calibrate a lens module of a projection apparatus, wherein the lens module has a tele mode and a wide mode, and the calibration method includes the following steps. The lens module is moved to an origin position by a movement element and a sensing element. when the lens module moves to the origin position, enabling the sensing element to provide an origin-position information signal, and when the sensing element provides the origin-position information signal, controlling the movement element to stop the lens module from moving, and setting the movement parameter value of the movement element as an origin parameter value. An image beam is controlled to focus on a first position on a reference plane in one of the tele mode and the wide mode. The image beam is controlled to focus on a second position on the reference plane in the other one of the tele mode and the wide mode. It is determined whether there is an offset between the first position and the second position. When the lens control element determines that the first position and the second position have an offset value, the lens control element correspondingly adjusts movement parameter values of the movement element in the tele mode and the wide mode based on an offset value between the first position and the second position, so that the image beam is focused on the same position of the reference plane after the adjustments are made in the tele mode and the wide mode.

Based on the above, the embodiments of the invention have at least one of the following advantages or effects. In the embodiment of the invention, the projection apparatus and the calibration method correspondingly adjust movement parameter values of the movement element in the tele mode and the wide mode based on the offset value between the first position and the second position, so that the image beam is focused on the same position of the reference plane after the adjustments are made in the tele mode and the wide mode. In this way, the origin of the imaging screen in the wide mode or the origin of the imaging screen in the tele mode is prevented from shifting, rendering a good image quality in the tele mode and the wide mode.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 is a block diagram of a projection apparatus according to an embodiment of the disclosure.

FIG. 2 is a partial schematic diagram of the structure of a projection apparatus according to an embodiment of the disclosure.

FIG. 3 is a flowchart of a calibration method according to an embodiment of the disclosure.

FIG. 4 is a schematic diagram of the structure of a first moving plate of a movement element according to an embodiment of the disclosure.

FIG. 5 is a schematic diagram of relative positions of the movement element and the second protruding block structure of the second moving plate according to an embodiment of the disclosure.

FIG. 6 is another schematic diagram of relative positions of the movement element and the first protruding block structure of the first moving plate according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

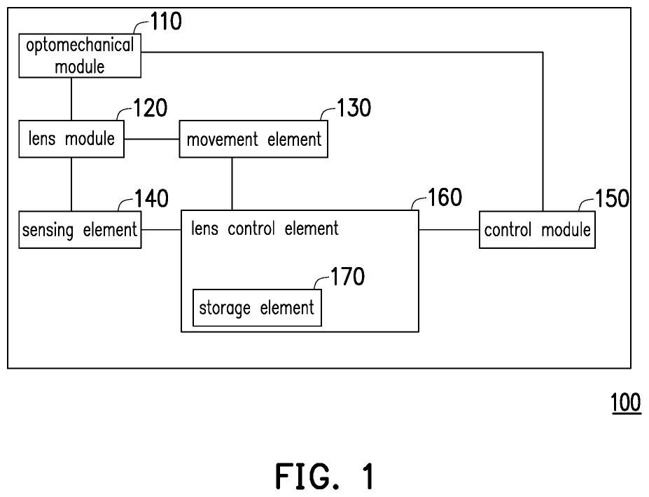

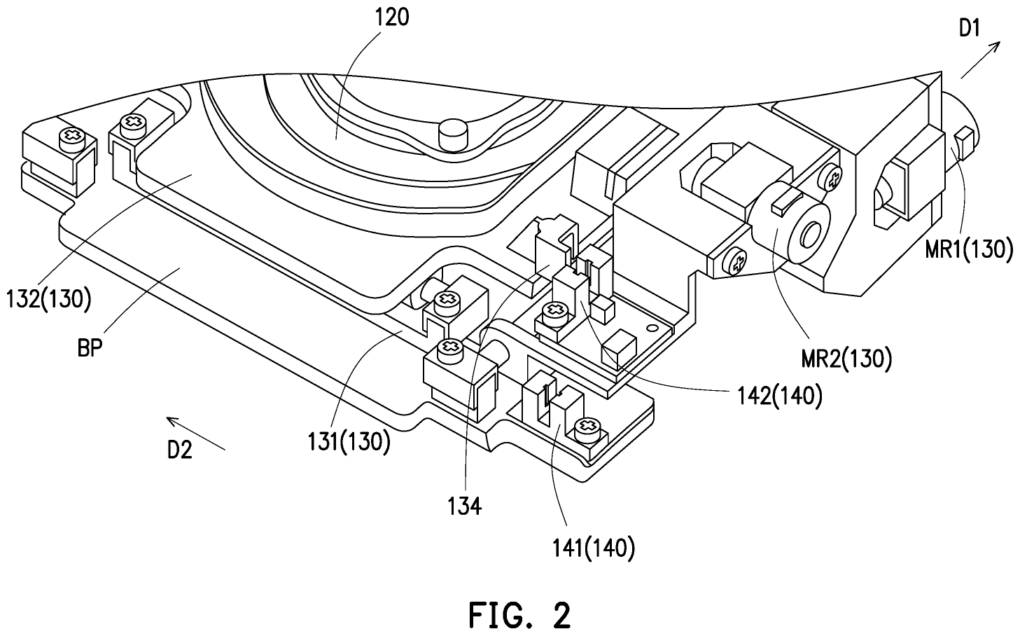

FIG. 1 is a block diagram of a projection apparatus according to an embodiment of the disclosure. FIG. 2 is a partial schematic diagram of the structure of a movement element and a sensing element according to an embodiment of the disclosure. In FIG. 1, in this embodiment, a projection apparatus 100 includes an optomechanical module 110, a lens module 120, a movement element 130, a sensing element 140, a control module 150, and a lens control element 160. The optomechanical module 110 is adapted to provide an image beam. The lens module 120 is a lens with a zoom ring, and has a tele mode and a wide mode, which may be adapted to focus the image beam on a reference plane in the tele mode and the wide mode. For example, the optomechanical module 110 may include a light source, an imaging element, and other optical elements for generating the image beam, and is electrically connected to the control module 150. The control module 150 may be adapted to control the optomechanical module 110 to form the image beam as needed. The light source includes, for example, one or more light-emitting diodes, or one or more laser diodes, and may be adapted to provide an illuminating light beam. The illuminating light beam is, for example, a single-color light having a wavelength range, or a mixed light beam of different wavelengths, such as white light synthesized by red, green, and blue light, but the invention is not limited thereto, and the type of the light source and the wavelength range of the illuminating light beam are not intended to limit the invention. The imaging element is, for example, a reflective or transmissive spatial light modulator (SLM). As a reflective spatial light modulator, it may be, for example, a reflective liquid crystal on silicon (LCOS) or a digital micro-mirror device (DMD), etc.; as a transmissive spatial light modulator, it may be a transparent liquid crystal panel, but the invention does not limit the type and form of the imaging element. In the embodiment, since sufficient teachings, suggestions, and implementation descriptions of the detailed steps and implementation of generating an image beam by the imaging element may be obtained based on common knowledge in the technical field, it is not be repeated herein.

Specifically, as shown in FIG. 1 and FIG. 2, the lens control element 160 is electrically connected to the lens module 120, the movement element 130, the sensing element 140, and the control module 150 to control and adjust the movement of the lens module 120, the movement element 130 is adapted to adjust the position of the lens module 120, and the sensing element 140 is adapted to detect the position of the lens module 120. For example, in this embodiment, the movement element 130 includes a plurality of stepping motors that are disposed correspondingly in a plurality of directions D1 and D2, there is only one stepping motor disposed in the same direction, and the movement parameter value of the movement element 130 is the number of steps of the stepping motor. In this way, by adjusting the number of steps of the stepping motors disposed in different directions, the movement element 130 may adjust the positions of the lens module 120 in different directions respectively, thereby changing the position of the image beam on the reference plane. On the other hand, in this embodiment, the sensing element 140 includes a plurality of sensing devices that are disposed correspondingly the directions D1 and D2, and there is only one sensing device disposed in the same direction. In this way, since only one sensing device is provided in the same direction, the electronic error of the sensing device itself may be minimized, thereby reducing the overall cost of product development.

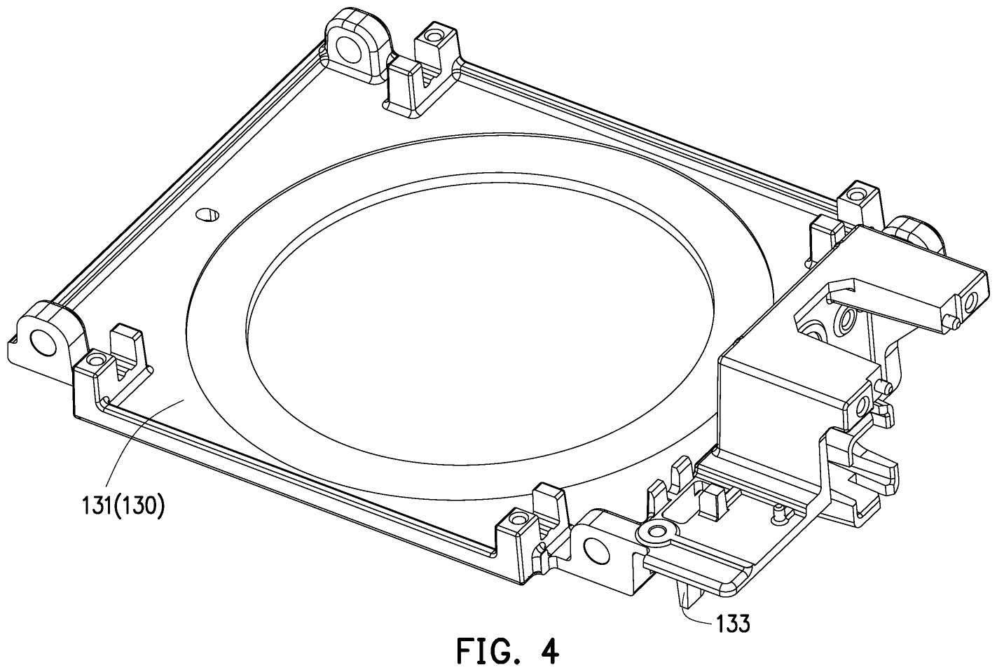

FIG. 4 is a schematic diagram of the structure of a first moving plate of a movement element according to an embodiment of the disclosure. Please refer to FIGS. 2 and 4. For example, the projection apparatus 100 includes a base plate BP. The movement element 130 includes a first stepping motor MR1, a second stepping motor MR2, a first moving plate 131 and a second moving plate 132. The first moving plate 131 is movably connected to the base plate BP. The first stepping motor MR1 and the second stepping motor MR2 are fixed on the base plate BP for driving the first moving plate 131 and the second moving plate 132 respectively. The first moving plate 131 is driven by first stepping motor MR1 to move along the direction D1. The second moving plate 132 is movably connected to the first moving plate 131. The second moving plate 132 is driven by the second stepping motor MR2 to move along the direction D2. The direction D1 is perpendicular to the direction D2, but not limited thereto. Moreover, the second moving plate 132 is configured to move relative to the first moving plate 131 along the second direction D2, and the second moving plate 132 is not able to move relative to the first moving plate 131 along the first direction D1.

The lens module 120 is connected to the second moving plate 132. Therefore, when the first moving plate 131 is driven by the first stepping motor MR1 to move along the first direction D1, the second moving plate 132 and the lens module 120 are moved along the first direction D1 with the first moving plate 131. When the second moving plate 132 is driven by the second stepping motor MR2 to move along the first direction D2, the lens module 120 is moved along the second direction D2 with the second moving plate 132, and the first moving plate 131 is not moved with the second moving plate 132.

The sensing element 140 may include a first sensing unit 141 and a second sensing unit 142. The first sensing unit 141 and the second sensing unit 142 are disposed on the base plate BP, and the first sensing unit 141 and the second sensing unit 142 are fixed on the base plate BP when the first moving plate 131 and/or the second moving plate 132 is moving. It should be further explained that the first sensing unit 141 is disposed on a moving path of the first moving plate 131, the second sensing unit 142 is disposed on a moving path of the second moving plate 132.

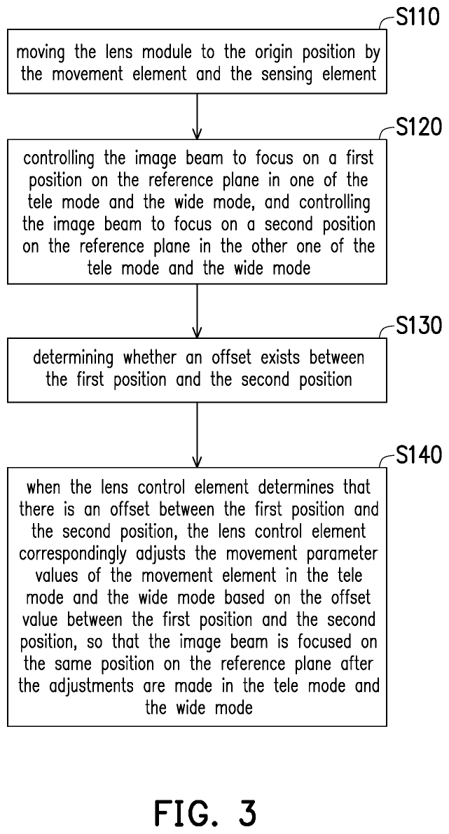

FIG. 3 is a flowchart of a calibration method according to an embodiment of the disclosure. In FIG. 3, in this embodiment, the calibration method may be executed by using the projection apparatus 100 of FIG. 1, for example. The following further describes how to use each component in the projection apparatus 100 to perform the calibration method of this embodiment.

First, in step S110, the lens control element 160 moves the lens module 120 to the origin position by the movement element 130 and the sensing element 140. For example, in this embodiment, moving the lens module 120 to the origin position includes the following processes. When the lens module 120 is driven by the movement element 130 to move to the origin position, the sensing element 140 may provide an origin-position information signal. When the sensing element 140 provides the origin-position information signal to the lens control element 160, the lens control element 160 controls the movement element 130 to stop the lens module 120 from moving, and sets the movement parameter value of the movement element 130 to an origin parameter value.

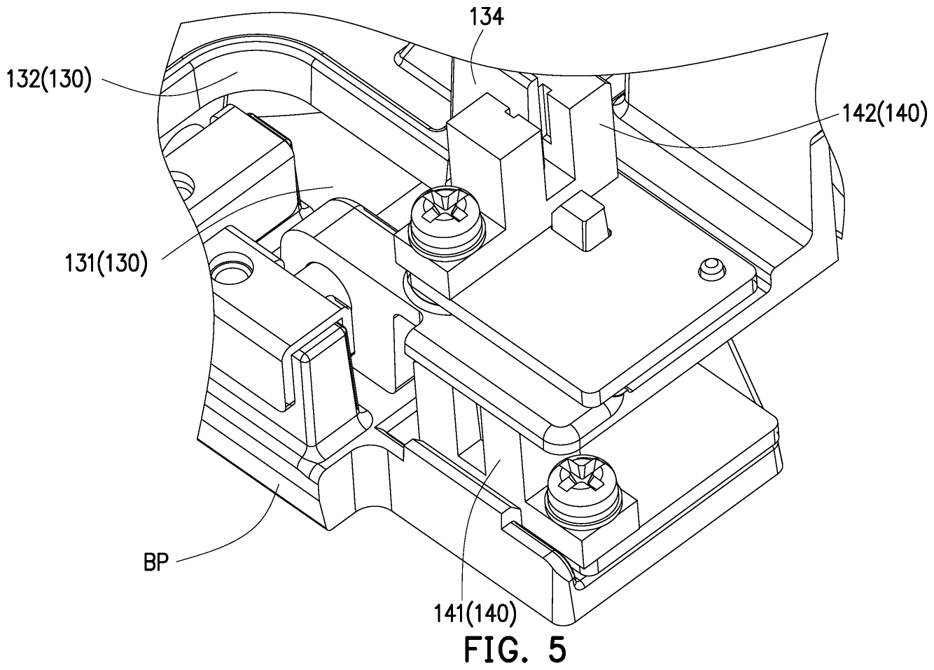

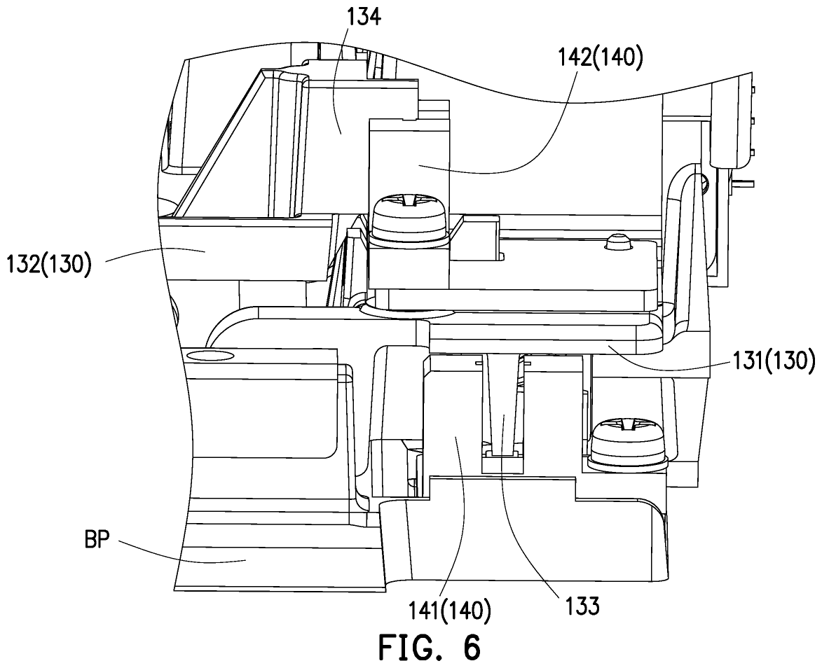

FIG. 5 is a schematic diagram of relative positions of the movement element and the second protruding block structure of the second moving plate according to an embodiment of the disclosure. FIG. 6 is another schematic diagram of relative positions of the movement element and the first protruding block structure of the first moving plate according to an embodiment of the disclosure. Please refer to FIGS. 2, 4, 5 and 6, for example, the first moving plate 131 has a first protruding block structure 133, and the second moving plate 132 has a second protruding block structure 134. The lens control unit 160 can control the first stepping motor MR1, such that the first stepping motor MR1 drives the first moving plate 131 to move in the direction D1. The lens control unit 160 can control the second stepping motor MR2, such that the second stepping motor MR2 drives the second moving plate 132 to move in the direction D2. The first moving plate 131 is moved and the first protruding block structure 133 is approaching to the first sensing unit 141 for triggering the first sensing unit 141. The second moving plate 132 is moved and the second protruding block structure 134 is approaching to the second sensing unit 142 for triggering the second sensing unit 142. When the first sensing unit 141 and the second sensing unit 142 are respectively triggered by the first protruding block structure 133 and the second protruding block structure 134, the lens module 120 is moved to the origin position, and the sensing element 140 generates the origin-position information signal and transmits the origin-position information signal to the lens control unit 160.

It should be further explained that the states shown in FIGS. 5 and 6 represent that the lens module 120 (not shown) has moved to the origin position. In addition, FIGS. 5 and 6 show the lens module 120 (not shown) at the origin position in different viewing angles. The state shown in FIG. 2 is that the lens module 120 is not at the origin position, such that the first protruding block structure 133 does not trigger the first sensing unit 141, and the second protruding block structure 134 does not trigger the second sensing unit 142.

For example, the origin-position information signal may be a voltage signal, a current signal, a resistance signal, a switch signal, or any signal that can be adapted to determine or transmit information. For example, the switch signal can be formed as follows. When the sensing element 140 is a normally open contact or a normally closed contact, once the protruding block structure triggers the sensing element 140, the power supplied to the movement element 130 is further cut off, and thereby stopping the movement of the lens module 120 to detect that the lens module 120 has shifted to the origin position. The first sensing unit 141 and the second sensing unit 142 of the sensing element 140 can be a photointerrupter, for example, the sensing element 140 is a reflective photointerrupter which is the model of ITR8103 manufactured by EVERLIGHT Electronics Co., Ltd. The lens control unit 160 can be a main board, wherein the main board is a core device of the projection apparatus, and integrates all operation management functions for the projection apparatus. The main board is configured to control the projection apparatus. The control unit 150 can be a microcontroller unit (MCU) disposed in the lens control unit 160 for controlling the optomechanical module 110 to form the image beam.

Then, in step S120, the lens control element 160 controls the image beam to focus on a first position on the reference plane in one of the tele mode and the wide mode, and controls the image beam to focus on a second position on the reference plane in the other one of the tele mode and the wide mode. For example, in this embodiment, when the lens module 120 moves to the origin position, the lens control element 160 adjusts the zoom ring of the lens module 120 to control the image beam to focus on the positions on the reference plane respectively in the tele mode and the wide mode.

Then, in step S130, the lens control element 160 determines whether there is an offset between the first position and the second position. When there is no offset between the first position and the second position, the lens control element 160 uses the second position or the first position as the preset coordinate origin position of the reference plane to act as a calibration coordinate origin position.

In contrast, when the lens control element 160 determines that there is an offset between the first position and the second position, it proceeds to step S140, where the lens control element 160 correspondingly adjusts the movement parameter values of the movement element 130 in the tele mode and the wide mode based on the offset value between the first position and the second position, so that the image beam is focused on the same position on the reference plane after the adjustments are made in the tele mode and the wide mode.

In another embodiment, the projection apparatus 100 further includes an image-capturing device (not shown), and the lens control element 160 captures an image of the reference plane through the image-capturing device to determine the offset value between the first position and the second position. The image-capturing device can be, for example, a camera, a video camera, or other devices with image-capturing function.

For example, the same position where the image beam is focused on the reference plane after the adjustments are made in the tele mode and the wide mode can be one of the first position and the second position. And steps of adjusting the movement parameter values of the movement element 130 in the tele mode and the wide mode correspondingly includes keeping the movement parameter value of the movement element 130 in one of the tele mode and the wide mode unchanged, and adjusting the movement parameter value of the movement element 130 in the other one of the tele mode and the wide mode, until the image beam is focused on one of the first position and the second position on the reference plane after the adjustments are made in the tele mode and the wide mode.

More specifically, the position where the image beam is focused on the reference plane in the tele mode is set as the first position, the first position is used as the preset coordinate origin position of the reference plane, and its coordinate position is (0, 0). Then, when the lens control element 160 controls the image beam to focus on the second position on the reference plane in the wide mode, the offset between the first position and the second position is set to be in an amount of (+a, +b), then the lens control element 160 may adjust the movement parameter value of the movement element 130 in the wide mode correspondingly, so that the image beam is focused on the first position on the reference plane in the adjusted wide mode. In this way, as the origin of the imaging screen in the wide mode or the origin of the imaging screen in the tele mode is not shifted, the calibration process is completed, providing a good image quality in the tele mode and the wide mode.

In addition, although the foregoing takes as an example the image beam that is focused on the first position on the reference plane after the adjustments are made in the tele mode and the wide mode, the invention is not limited to this. In other embodiments, the lens control element 160 adjusts correspondingly the movement parameter values of the movement element 130 in the tele mode and the wide mode at the same time, so that it is focused on the second position on the reference plane or other preset positions in the tele mode and the wide mode that have been adjusted, as long as the image beam is focused on the same position on the reference plane in the adjusted tele mode and the adjusted wide mode.

On the other hand, in this embodiment, when the image beam is focused on the first position or the second position on the reference plane after the adjustments are made in the tele mode and the wide mode, the lens control element 160 records and store the offset value between the first position and the second position at this time and the movement parameter value of the movement element 130 in a storage element 170 of the projection apparatus 100. Moreover, the storage element 170 may be disposed in the lens control element 160 (ex. main board), or the storage element 170 may be disposed outside and is electronically connected with the lens control element 160. The lens control element 160 generates an offset compensation table information according to the offset value and the movement parameter value stored in the storage element 170. In another embodiment, the offset compensation table information can be stored in EEPROM (Electrically Erasable Programmable read only memory) of the lens control element 160. Through establishing and reading the offset compensation table information, during each process of the calibration, the lens control element 160 may read the corresponding movement parameter values of the movement element 130 in the tele mode and the wide mode recorded in the offset compensation table information based on the offset value between the first position and the second position, and the movement parameter values of the movement element 130 in the tele mode and the wide mode may be automatically set to complete the calibration without the need for a manual calibration process. When subsequent calibrations are needed, the user may refer to the movement parameter values previously stored. The storage element 170 can be a computer memory. For example, the storage element 170 includes a non-volatile storage device, a volatile storage device or a frame memory, such that the storage element 170 can store the offset value between the first position and the second position at this time and the movement parameter value of the movement element 130.

In other words, when the lens control element 160 determines that there is an offset between the first position and the second position, the lens control element 160 may perform step S140 by manually adjusting the movement parameter values of the movement element 130 in the tele mode and the wide mode, so that the image beam is focused on the same position of the reference plane after the adjustments are made in the tele mode and the wide mode. Or, the lens control element 160 may also perform step S140 by automatically reading the movement parameter values of the movement element 130 in the tele mode and the wide mode corresponding to the offset compensation table information in the storage element 170 to obtain the movement parameter value that is adjusted correspondingly to the offset value between the first position and the second position, so as to make the image beam is focused on the same position on the reference plane after the adjustments are made in the tele mode and the wide mode. The invention is not limited to this.

In summary, the embodiments of the invention have at least one of the following advantages or effects. In the embodiments of the invention, based on the offset value between the first position and the second position, the projection apparatus and the calibration method correspondingly adjust the movement parameter values of the movement element in the tele mode and the wide mode, so that the image beam is focused on the same position on the reference plane in the tele mode and the wide mode after the adjustments are made. In this way, the origin of the imaging screen in the wide mode or the origin of the imaging screen in the tele mode is prevented from shifting, thereby providing a good image quality in the tele mode and the wide mode.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a lens module, having a tele mode and a wide mode, and adapted to focus an image beam on a reference plane in one of the tele mode and the wide mode;
a movement element, adapted to adjust a position of the lens module;
a sensing element, adapted to detect the position of the lens module; and
a lens control element, electrically connected to the lens module, the movement element, and the sensing element, wherein: when the movement element drives the lens module to move to the origin position, the lens module triggers the sensing element, the sensing element provides an origin-position information signal to the lens control element, the lens control element controls the movement element to stop the lens module from moving, and the lens control element sets the movement parameter value of the movement element to an origin parameter value, the lens control element controls the image beam to focus on a first position on the reference plane in one of the tele mode and the wide mode, and the lens control element controls the image beam to focus on a second position on the reference plane in the other of the tele mode and the wide mode; the lens control element determines whether an offset exists between the first position and the second position; when the lens control element determines that an offset value exists between the first position and the second position, the lens control element correspondingly adjusts a movement parameter value of the movement element in the one of tele mode and the wide mode based on the offset value between the first position and the second position, so that the image beam is focused on the same position on the reference plane in the tele mode and the wide mode that have been adjusted.

2. The projection apparatus according to claim 1, wherein the same position where the image beam is focused on the reference plane in the tele mode and the wide mode that have been adjusted is one of the first position and the second position.

3. The projection apparatus according to claim 2, wherein the movement element keeps the movement parameter value unchanged in one of the tele mode and the wide mode, and adjusts the movement parameter value of the movement element in the other of the tele mode and the wide mode, until the image beam is focused on one of the first position and the second position on the reference plane in the tele mode and the wide mode that have been adjusted.

4. The projection apparatus according to claim 3, wherein when the image beam is focused on the first position or the second position on the reference plane in the tele mode and the wide mode that have been adjusted, the lens control element records and stores the movement parameter value of the movement element at this time in a storage element, the lens control element produces an offset compensation table information according to the offset value and the movement parameter value.

5. The projection apparatus according to claim 1, further comprising:
a storage element, adapted to store offset compensation table information, wherein based on the offset value between the first position and the second position, the lens control element reads the corresponding movement parameter value of the movement element in the tele mode and the wide angle that is recorded in the offset compensation table information.

6. The projection apparatus according to claim 1, wherein: the movement element comprises a protruding block structure; and when the movement element drives the lens module to the origin position, the protruding block structure triggers the sensing element, the sensing element generates the origin-position information signal.

7. The projection apparatus according to claim 1, wherein: the movement element comprises a plurality of stepping motors disposed correspondingly in a plurality of directions; there is only one of the stepping motors disposed in the same direction; and the movement parameter value of the movement element is a number of steps of the stepping motors.

8. The projection apparatus according to claim 1, wherein the sensing element comprises a plurality of sensing devices disposed correspondingly in a plurality of directions, and there is only one of the sensing devices disposed in the same direction.

9. A calibration method for calibrating a lens module of a projection apparatus, wherein the lens module comprises a tele mode and a wide mode, and the calibration method comprising:
moving the lens module to an origin position by a movement element and a sensing element, when the lens module moves to the origin position, enabling the sensing element to provide an origin-position information signal, and when the sensing element provides the origin-position information signal, controlling the movement element to stop the lens module from moving, and setting the movement parameter value of the movement element as an origin parameter value;
controlling an image beam to focus on a first position on a reference plane in one of the tele mode and the wide mode;
controlling the image beam to focus on a second position on the reference plane in the other of the tele mode and the wide mode; and
determining whether an offset exists between the first position and the second position, wherein when the lens control element determines that the first position and the second position has an offset value, the lens control element correspondingly adjusts a movement parameter value of the movement element in one of the tele mode and the wide mode based on the offset value between the first position and the second position, so that the image beam is focused on the same position on the reference plane in the tele mode and the wide mode that have been adjusted.

10. The calibration method according to claim 9, wherein: the same position where the image beam is focused on the reference plane in the tele mode and the wide mode that have been adjusted is one of the first position and the second position.

11. The calibration method according to claim 10, wherein correspondingly adjusting the movement parameter value of the movement element in the tele mode and the wide mode comprises:
keeping the movement parameter value of the movement element in one of the tele mode and the wide mode unchanged, and adjusting the movement parameter value of the movement element in the other of the tele mode and the wide mode, until the image beam is focused on one of the first position and the second position on the reference plane in the tele mode and the wide mode that have been adjusted.

12. The calibration method according to claim 11, further comprising:
when the image beam is focused on the first position or the second position on the reference plane in the tele mode and the wide mode that have been adjusted, recording and storing the movement parameter value of the movement element at this time in a storage element, the lens control element produces an offset compensation table information according to the offset value and the movement parameter value.

13. The calibration method according to claim 9, further comprising:
based on the offset value between the first position and the second position, reading the corresponding movement parameter value of the movement element in the tele mode and the wide angle recorded in offset compensation table information stored in a storage element.

14. The calibration method according to claim 9, wherein the movement element comprises a protruding block structure, and enabling the sensing element to provide the origin-position information signal comprises:
triggering the sensing element by the protruding block structure when the movement element drives the lens module to the origin position, and
generating the origin-position information signal by the sensing element.

15. The calibration method according to claim 9, wherein: the movement element comprises a plurality of stepping motors respectively disposed correspondingly in a plurality of directions; there is only one of the stepping motors disposed in the same direction; and the movement parameter value of the movement element is a number of steps of the stepping motors.

16. The calibration method according to claim 9, wherein the sensing element comprises a plurality of sensing devices disposed correspondingly in a plurality of directions, and there is only one of the sensing devices disposed in the same direction.
